(19) United States
(12) Patent Application Publication
(10) Pub. No.: US 2015/0052105 A1
(43) Pub. Date: Feb. 19, 2015

(54) CLOUD-BASED SYNCHRONIZATION OF RELATED FILE SETS

(71) Applicant: Filelize, Inc., Mercer Island, WA (US)

(72) Inventor: Tim D. Nguyen, Mercer Island, WA (US)

(21) Appl. No.: 14/457,529

(22) Filed: Aug. 12, 2014

Related U.S. Application Data
(60) Provisional application No. 61/866,866, filed on Aug. 16, 2013.

(51) Int. Cl. G06F 17/30

(52) U.S. Cl. CPC G06F 17/30174
USPC 707/626

(57) ABSTRACT

Files in active use may be detected. Files related to the active files may also be determined. A set of active files and related files may be automatically synchronized to one or more cloud-based storage services. A user may be provided with access to the related file set using any device having access to the cloud-based storage service.

### CROSS-REFERENCE TO RELATED APPLICATION

This application claims benefit under 35 U.S.C. §119(e) of U.S. Provisional Patent Application No. 61/866,866, filed Aug. 16, 2013, the contents of which are incorporated herein by reference in its entirety.

### BACKGROUND

When working with files on a personal computer, mobile phone, or other computing device, it may be difficult and time consuming to find files related to the work being done. There may be a large number of files scattered throughout various locations. Shortcuts to files may be generated, but must generally be manually edited by the user. Searching for files may be slow and ineffective. The issues associated with finding related files may be even more challenging when encountered in the context of cloud-based storage solutions, in which the same file or set of files may exist in multiple locations, such as a local computing device and one or more cloud-based storage providers. Users may forget to copy the documents they are working on to cloud-based storage, and may also fail to anticipate which documents they might want to view or edit at a later time. As a result, the files needed by the user are often unavailable, even when cloud-based storage is used.

### BRIEF DESCRIPTION OF THE DRAWINGS

FIG. 1A is a block diagram depicting an environment for automatic cloud-based synchronization of related file sets.

FIG. 1B is a block diagram depicting an alternative view of an embodiment for automatic cloud-based synchronization of related file sets.

FIG. 2 is a flowchart depicting an embodiment of a computer-implemented method for automatically synchronizing sets of related file to one or more cloud-based services.

FIG. 3 is a flowchart depicting an embodiment of limiting file synchronization capabilities to allow for improved monetization of a system for synchronizing related file sets.

FIG. 4 is a flowchart depicting an embodiment for providing access to sets of related files synchronized to one or more cloud services.

FIG. 5 is a flowchart depicting an embodiment of using synchronized sets of related files on multiple devices.

FIG. 6 is a flowchart depicting an embodiment for determining a set of related files by constructing a weighted graph.

FIG. 7 is a block diagram depicting an embodiment of a user interface for providing access to sets of related files synchronized to one or more cloud services.

FIG. 8 is a block diagram depicting an embodiment of a background process for detecting and maintaining a synchronization folder.

### DETAILED DESCRIPTION OF ILLUSTRATIVE EMBODIMENTS

Cloud-based storage services may provide a convenient mechanism for accessing files in situations where more conventional methods, such as storing files on the hard drive of a personal computer, are not practical. However, various difficulties may be associated with using cloud-based storage. These difficulties include remembering when to copy files to and from cloud-based storage, synchronizing files that have changed on either local storage or in the cloud, and predicting which files might be needed. Various aspects of the present disclosure may be employed to address these and other issues. For example, consistent with aspects of the present disclosure, an embodiment might automatically provide users with access to recently used files, email attachments, web pages and so forth, and to related files that, while not explicitly accessed by a user, may nevertheless be wanted by the user at a later time. Embodiments may provide access to these files by determining which files have been accessed by a user, locate files that are related to the accessed files, and maintain synchronized copies of both accessed and related files in the cloud. These aspects may furthermore be provided with a minimal amount of user involvement, so that a user does not need to remember to copy files to cloud-based storage.

Embodiments of the present disclosure may be employed to provide a user with remote access to files, without requiring the user to choose which files should be made available for remote access. One or more monitoring components may receive notifications of active files which may comprise files that are created, opened, and edited on a client device. A user interface may provide a summary of these files to the user. A mechanism may then be employed to identify additional files that are related to the created, opened, or edited file. These may also be displayed in the user interface. The set of related files, including the created, opened, or edited file, may be copied to a synchronization folder from which they can be propagated to a cloud-based storage solution. From cloud-based storage, the files may be viewed or edited from various devices such as personal computers, tablets, and smartphones. Changed files may be propagated back to the synchronization folder and reconciled with copies of the files held on the client device. The system may be provided as a web-based service, which may be monetized by basing usage fees on the total number of files that may be synchronized, or by basing fees on the number of created, opened, or edited files that may be synchronized.

An embodiment of a system for providing remote access to files may be configured to detect a file becoming active, wherein an active file is one that is created, opened, or edited on a client device. The system may be further configured to detect related files, wherein related files are detected through means including files located in the same folder, within the same hierarchy of folders, referred to by the same document, linked to by the same document, files created, opened, or edited near to the time the active file was used, and so forth. Active files and related files may be copied to a temporary storage location, from which they may be synchronized with a cloud-based storage system. Files stored in the cloud-based storage system may be modified. Subsequent to being modified, the file may be copied back to the temporary storage location. The file at its original location may be synchronized with the copy of the file in the temporary storage location.

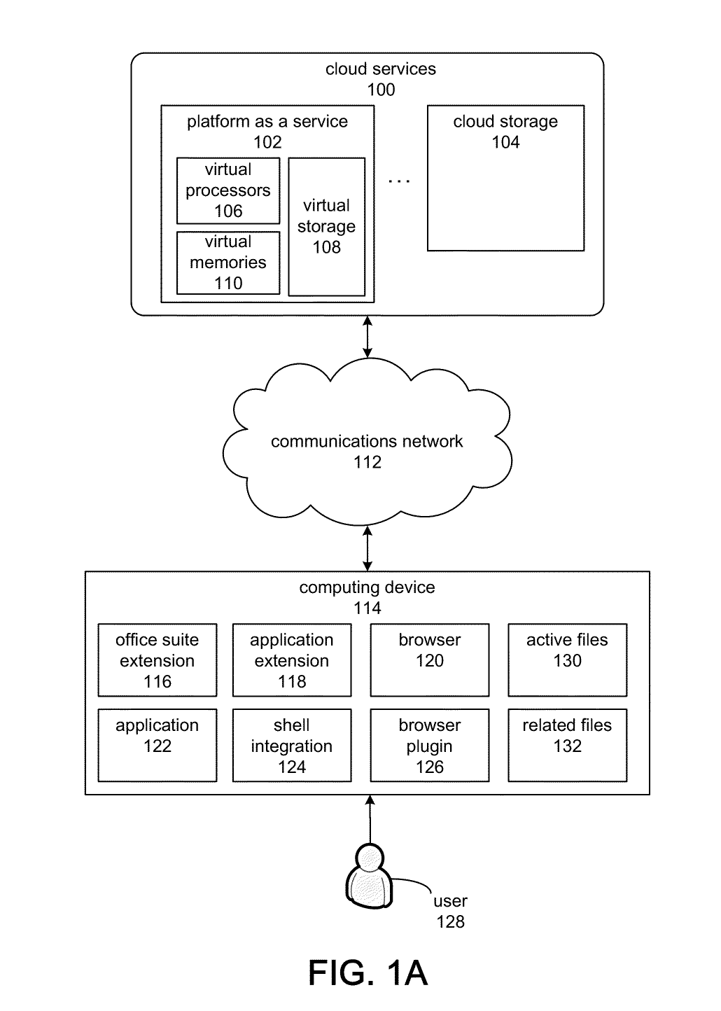

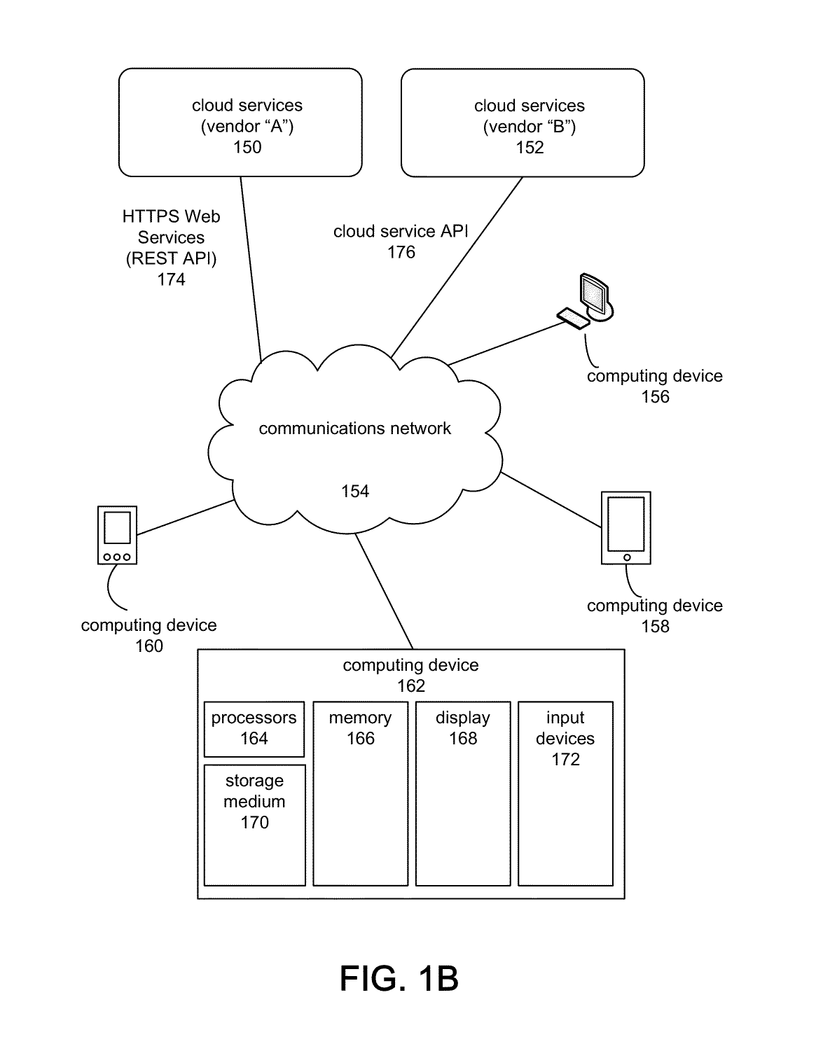

FIG. 1A depicts an environment for cloud-based synchronization of a related file set. Cloud services 100 may operate in a data center or similar environment comprising multiple physical or virtual computing devices implementing a platform as a service 102 and/or cloud storage 104. A computing device may be any of various means for providing computing resources, such as personal computers or servers communicatively coupled to a network. A computing device may be implemented directly through hardware, or may be embodied by a virtualized computing resource such as a virtual machine.

Cloud services 100 may be configured to provide platform as a service 102, comprising one or more virtual processors 106, virtual memories 110, and virtual storage 108. Platform as a service 102 may be provided as a virtual machine configured to provide cloud-based storage functions. Platform as a service 102 may be configured to operate various processes such as a database management system and/or web server. These may expose various application programming interfaces for storing and retrieving documents. An interface standard or protocol such as representational state transfer (“REST”) may be used to interact with platform as a service 102. Web servers, client applications, and so forth may communicate with a database management system through various protocols or interfaces, such as extensible markup language, open database connectivity, sql client connectors, and so forth. Cloud storage 104 may be similar to platform as a service 102, but dedicated for providing storage functionality through a protocol or interface, such as an interface conforming to REST.

A communications network 112, such as the Internet, may be used to communicate between a computing device 114 and cloud services 100. In various embodiments communications network 112 may comprise a private intranet, virtual-private network (“VPN”), and so forth. Cloud services 100 may comprise various infrastructure components supplied and operated by a third party. In some embodiments, cloud services 100 may comprise internal cloud services operated by those practicing the embodiments described herein.

A user 128 of computing device 114 may view, create, or edit various documents and other files stored initially on computing device 114. Active files 130 may comprise files that are created, opened, or edited. Related files 132 may comprise files determined to be related to active files 130. For example, unopened files attached to an email may be related to a file that was opened in the same email. The latter may be treated as an active file 130 and the former as a related file 132. The actions may be intercepted and monitored by various software modules operating on computing device 114. For example, an office suite extension 116 may monitor for the activation of various files being viewed, created, or edited within an office software suite, which may for example comprise e-mail, word processing, and spreadsheet functions. A foreground or background application 122 may monitor for viewed, created, or edited files. The term active file may be used to refer to any file that has been recently created, viewed, or edited. Various other examples of software modules that may monitor for active files include application extensions 118, shell integration 124, browsers 120, and browser plugins 126. Files may be opened from any location, such as a local hard drive, network drive, optical disk drive, flash drive, and so on. Active files may also refer to attachments opened from other programs, such as an e-mail program or web browser.

FIG. 1B depicts another view of an embodiment for cloud-based synchronization of a related file set. Computing device 162, which may comprise microprocessors 164 coupled to memory 166. Instructions executable by the processor may be stored on storage medium 170, which may comprise various forms of non-transitory computer readable media such as random access memory, read-only memory, optical disks, magnetic disks, flash memory, and so on. Computing device 162 may also comprise a display 168 and input devices 172, such as a keyboard, mouse, touch panel, voice input, and so forth. Computing device 162 may also comprise various other forms of input and output devices, such as audio speakers. Various examples of computing device 162 include, but are not limited to, personal computers, laptops, cell phones, smart phones, tablet computers, and so on. Various operating systems may coordinate the operation of other components of computing device 162.

A user of computing device 162 may also use various other computing devices 156, 158, and 160. These may also be used, in addition to computing device 162, to view, create, or edit documents stored on computing device 162. Embodiments of the invention may allow sets of related files to be automatically synchronized between computing device 162 and one or more of cloud services 150, provided by vendor “A,” and cloud services 152, provided by vendor “B.” When sets of related files are automatically synchronized, each of computing devices 156, 158, 160, and 162 may have access to up-to-date versions of related files. Embodiments may synchronize files from various locations on a computing device such as computing device 164 to one or more cloud services, such as 150 and 152. From cloud services 150 and 152, the related documents may be accessed. Embodiments may provide various means to automatically determine documents related to active or recently active files.

Multiple cloud service vendors may supply locations for cloud-based storage, such as the depicted cloud services 150 and 152. Various protocols may be used to interact with the cloud services, the interaction generally comprising storing and retrieving files. Examples of these protocols are web service protocols over hypertext transfer protocol secure (“HTTPS”) 174, which may employ a REST-based sub-protocol, and various cloud service application programming interfaces (“APIs”) 176.

In some cases and embodiments, files may be synchronized to multiple cloud-based storage providers. For example, a user might be able to indicate that files from one location on a storage device should go to service “A,” while files of another type or another location should go to “service B.” In some embodiments the destination cloud service might be based on file type, file size, location, or other properties of the file. For example, files above a certain size might be synchronized to a cloud-based storage provider that specializes in large files. The destination cloud service might also be selected based on the identity of the user or various other factors.

As used herein, the terms “cloud,” “cloud services,” and “cloud solutions” refer to off-premises computing resources, of the type sometimes supplied by third party vendors. The terms “cloud storage,” “cloud storage system,” and “cloud storage solution” refer to off-premises computing resources that are directed to the storage and retrieval of data. A cloud service may encompass cloud storage. A variety of means may be used to access cloud services, including HTTP, REST-based protocols, APIs, and so forth. Cloud services may be provided at a data center connected via gateways and/or routers to the Internet. The data center may comprise one or more computing devices, such as computers or computer servers, interconnected by an internal network. A variety of means may be employed in the data center to provide for cloud storage, including the use of relational or non-relational database management systems, storage area networks, and so forth.

A cloud storage service may provide various means for automatically synchronizing the contents of a particular folder with a copy of that folder on the cloud. For example, a cloud service might be configured to automatically synchronize between the “C:\cloudservice\myfolder” directory on a local computing device and a “myfolder” location provided to a user by a cloud service provider.

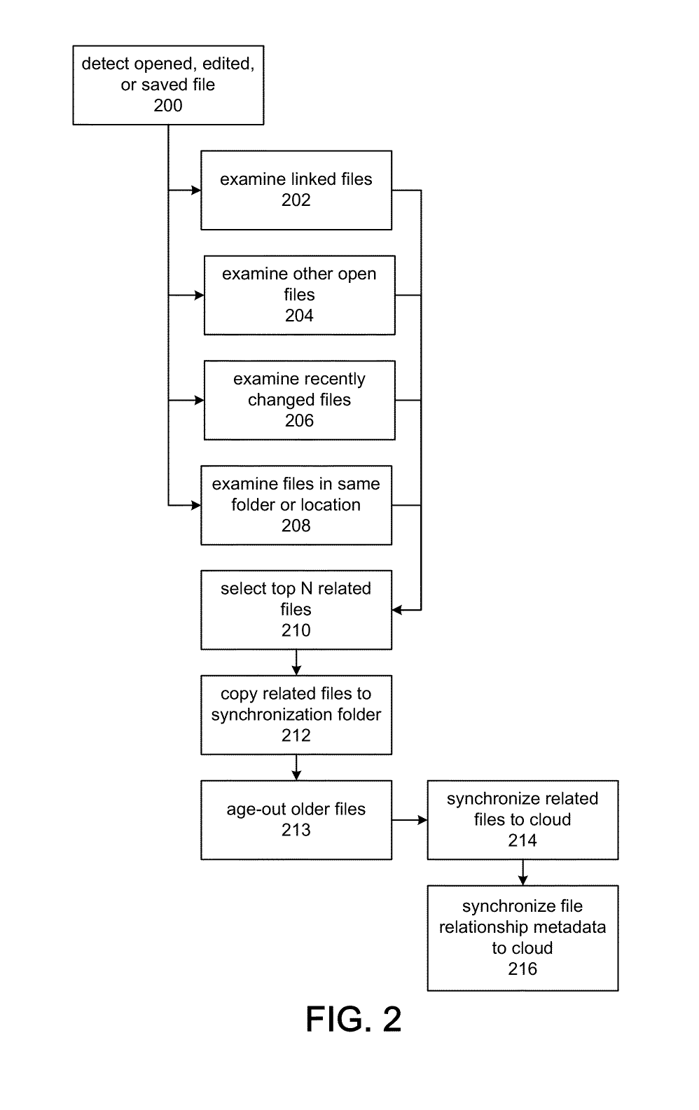

FIG. 2 depicts an embodiment of a computer-implemented method for automatically synchronizing sets of related file to one or more cloud-based services. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

At operation 200, an active file may be detected. A process, plugin, application extension, and so on may be configured to detect opened, created, edited, saved, or deleted files. Embodiments may also provide a mechanism for a user to indicate via some action that a file should be considered active.

Operations 202, 204, 206, and 208 depict various non-limiting examples of operations that may be used to locate files that are related to active files. Operation 202 depicts examining files referred to, or linked, in an active file. Files that are active at the same time as another active file may be considered related, as depicted by operation 204. Similarly, files that have recently become inactive may be related to currently active files. Operation 206 depicts this determination. In some embodiments, a threshold number of files having the most recent modified dates may be selected for synchronization.

Examination of open or recently changed files may include examination of Internet-based files, locations, or other resources. Web history information may be synchronized between a client and one or more cloud-based storage providers or other web services via history file or through programming interfaces available on the client and/or cloud-based storage provider or web service. Embodiments may selectively synchronize web history information based on potential relevance to other files being synchronized. For example, an embodiment may determine that a resource remote to the computing device has been accessed by the computing device. This may occur, for example, when a user of the computing device accesses a web site through a web browser. Embodiments may then determine to store information describing the resource at a remote storage location, such as a cloud-based storage service. The determination to store the description of the remotely located resource may be based on a relationship between the remotely located resource and other files recently accessed on the computing system. The relationship may be detected using the various techniques described herein, such as relationships based on time of access, content, attachments, links, and so on. For example, web sites that are referred to in URLs embedded in an accessed document could be considered related.

Embodiments may utilize the information to display descriptions of recently accessed web sites or other remotely located resources to a user. Accordingly, a user may be provided with convenient access to Internet-based sites that were accessed while working on one computing device, even when the same user is later utilizing a different computing device.

Operation 208 depicts another example involving files located in the same folder as an active file. Embodiments may also examine nearby folders, such as parent or child folders, to locate related files. Files in the same directory, a parent directory, or a child directory may be more likely to be related than files located in disjoint directories.

At operation 210, a number of related files may be selected for synchronization. The number of files selected may be based on a variety of factors such as a service level, an estimated degree of relationship between the files, user preference, and so on. The service level may limit the number of active files to be synchronized and/or the number of related files. The service level may also limit the total number of files (both active and non-active) that may be synchronized.

The files to be selected may be based on various criteria. In an embodiment, the most recently modified files are to be selected. Other embodiments may use the probability or degree of relationship to determine which files to select.

At operation 212, related files may be copied from their original locations to a synchronization folder located on the local computing device. The synchronization folder may allow for improved integration with a variety of cloud service providers, as well as allowing for embodiments to inject customized conflict resolution mechanisms. In some embodiments, synchronization may occur directly between a client and a cloud provider or other web service. Communication with a cloud provider or web service may be employed to identify, track, download, or upload files during a synchronization process.

Operation 213 depicts aging out older files. Files that have not been accessed recently may be removed from the list of files to be synchronized. This may apply to active files, related files, or both active and related files. As used herein, the term “active file” means that a file that has recently been viewed, edited, or created. The term “related file” means files that are relevant in some way to an active file. Older files may be less likely to be needed, and therefore may be aged out if their presence would otherwise limit the number of available files that could be synchronized. Embodiments may combine age with other factors, such as degree of relevance, to determine which files to age out. A file that is aged out may be removed from the synchronization folder, or excluded from synchronization through some other means. In some embodiments, related files may be aged out on a different schedule than active files. Embodiments may also age out related files while not aging out active files. In some embodiments, aging out of related files may occur each time an active file is open.

Synchronization with a cloud-based service may then be initiated, as depicted by operation 214. This may comprise invoking an application programming interface supplied by the cloud services vendors. A synchronization process provided by the cloud services vendor may, in some embodiments, be employed to synchronize between a local synchronization folder and the cloud. Other embodiments may bypass the synchronization folder by and synchronize each related file with one or more cloud services directly from each files original location on the local device.

In an embodiment, files that are aged out of the set of files to be synchronized may be identified in a history list of recent files. Embodiments may remove files from the synchronization folder referred to in step 212 in order to prevent the aged-out file from being synchronized. Embodiments may display the history list in a user interface. The embodiment might receive an indication that the user is again interested in an item in the history list. In response to receiving this indication, an embodiment might cause the history list file to be retrieved. This may comprise resuming automatic synchronization of the file. In some cases, a file or other data corresponding to a history list item may be retrieved synchronously, i.e., in response to the item being selected in a user interface and with a minimal amount of delay.

In a further embodiment, aged-out items may be moved to an archive folder at a cloud-based storage location. Files may be kept in the archive folder for long-term storage. The files may be accessed or searched through a variety of mechanisms. Various user preferences, administrative preferences, and so forth may control whether this feature is activated and, when activated, how many or what type of files may be archived.

Operation 216 depicts synchronizing various types of metadata to one or more cloud services. The metadata may describe various factors about the files and the set of related files. For example, in various embodiments metadata may include a listing of the related files, information indicative of their original locations on the local device, modification dates, information indicative of the relationship between files, last synchronization time, and so forth. Embodiments may employ metadata for various purposes including re-synchronizing files on the local device, generating displays of available files on devices other than the local device, and so forth.

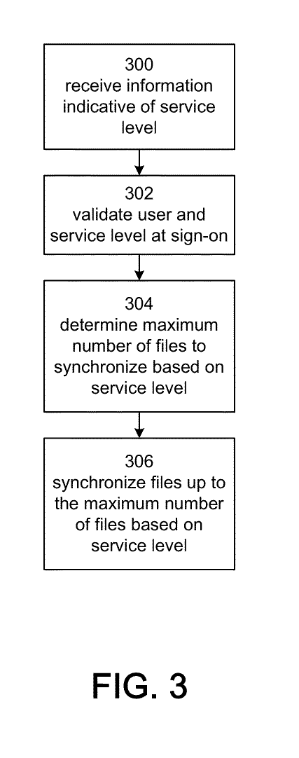

FIG. 3 depicts an embodiment of limiting file synchronization capabilities to allow for improved monetization of a system for synchronizing related file sets. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Operation 300 depicts receiving information indicative of a service level. For example, a user might enroll in a service for synchronizing related file sets via a web-based interface. Various service levels might be chosen based on the user's needs and willingness to pay. Operation 302 depicts subsequent validation of the user, including retrieval of the user's selected service level. The user's selected service level may be stored in and retrieved from a database accessible to the local computing device, which may include a database hosted by within the cloud.

Operation 304 depicts determining, based on the user's selected service level, a maximum number of files to synchronize. For example, a user whose service level is “free” might be allowed to automatically synchronize up to 10 files, while a user paying a monthly fee might be able to synchronize up to 50 files. Embodiments may also allow for a predefined number of root files and a predefined number of related (e.g. linked) files. One non-limiting example involves identifying up to 10 active files based on a “free” service tier, and allowing for 10 related files to also be synchronized. Numerous alternative arrangements are possible. Various additional features may be added or removed based on a user's service level. For example, higher-tiered service levels may employ improved algorithms for detecting related files. Embodiments may allow for the number of permissible synchronized files to be increased based on a user referring others to the service.

At operation 306, the files may be synchronized up to the maximum number of files allowed according to the selected service plan. Embodiments may enforce the maximum by copying no more than the maximum number of files to the synchronization folder. Access to the synchronization folder may be restricted from the user to prevent circumvention of the maximum. Alternatively, the synchronization process may select no more than the maximum number of files from the synchronization folder, even though additional files may be located there.

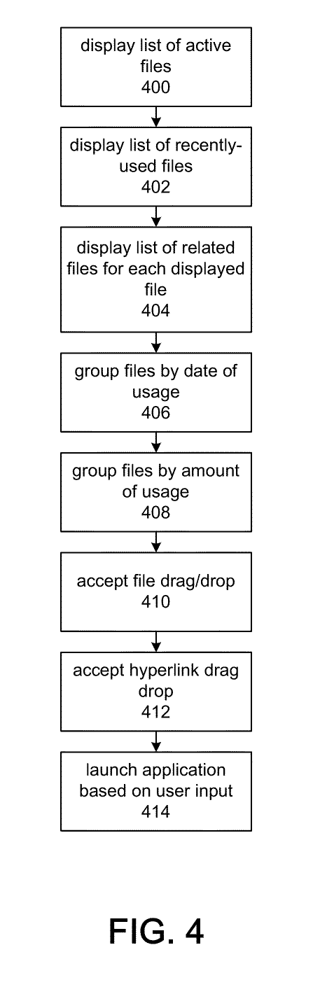

FIG. 4 depicts an embodiment of a process, including a user interface, which may provide access to sets of related files synchronized to one or more cloud services. The depicted embodiment may also include, in a user interface, a mechanism to allow a user to specify additional related files, or root files to be synchronized. A user interface of the type depicted in FIG. 4 may be provided on the computing device from which files are synchronized, and may also be provided on other computing devices, such as smartphones or tablet computers.

Although depicted as a sequence of operations, those of ordinary skill in the art will appreciate that the operations depicted in FIG. 4 are intended to be illustrative and should not be construed as limiting the scope of the disclosure. Furthermore, those of ordinary skill in the art will appreciate that at least some of the depicted operations may be altered, omitted, reordered, or performed in parallel.

A user interface may display lists of active files, as depicted by operation 400. In addition, recently-used files may also be displayed, as depicted by operation 402. The user interface may provide, with each displayed file, relevant information such as the name of the file, the type of file, the date and time it was accessed, the author, and so forth. A summary of the file's contents might also be provided. Embodiments may include checkboxes, context menus, and so forth to allow for the files to be marked for synchronization. However, embodiments may determine to synchronize such files automatically. If a limit is imposed on the maximum number of files, the user interface may provide a notification of which files will be synchronized and which files will not be. The user interface may provide means for selecting which files to include and which to exclude.

Operation 404 depicts displaying, for each file, a list of related files that may also be synchronized. These may be displayed in a manner indicative of their relationships to other files. For example, a list of related files may be displayed subsequent to each of the files listed in operation 400. The user interface may also provide an indication of the degree of relationship to the file, such as listing the related files in decreasing order of relevance. The user interface may provide means for including or excluding each of these files from synchronization, and for indicating whether or not the file will be synchronized.

The user interface may provide various options for ordering and grouping the displayed files. Operation 406 depicts grouping files by date of usage. Operation 408 depicts grouping files by amount of usage. The term grouping may refer to sets that have a characteristic falling within a certain range. For example, files used for less than one hour might be assigned to one group, and files used for more than one hour but less than ten to another group. In place of grouping files, some embodiments may order files or other elements according to characteristics such as those evaluated in operations 406 and 408.

Embodiments may, as depicted by operation 410, accept drag and drop operations. A file dragged and dropped within some portion of the user interface may be marked for synchronization. Similarly, a file dragged and dropped from the user interface may be excluded from synchronization.

Various files and objects may be dragged and dropped. For example, operation 412 depicts dragging and dropping a hyperlink. A hyperlink or other element, such as another file, email attachment, calendar item, and so forth, may be dragged onto another document in the user interface to indicate that it is related to an active file and should also be synchronized. Embodiments may allow related files to be associated with active files as explicitly indicated by a user, or through an automatic mechanism. Embodiments may synchronize the target of the hyperlink to the cloud, or include the hyperlink in metadata associated with the file. The user interface may display related hyperlinks alongside related files, and allow for the hyperlink to be opened in response to a user action, such as a click or double click.

Operation 414 depicts providing access to the displayed files, related files, and hyperlinks through a user interface. A user interface may respond to user input such as clicks and double-clicks by launching a corresponding application to display or edit the document. The user interface may open the document directly from cloud storage, from a local cache, from a synchronization folder, or from the original location. The user interface may select the location based in part on factors such as the current device, user preference, network availability and so forth.

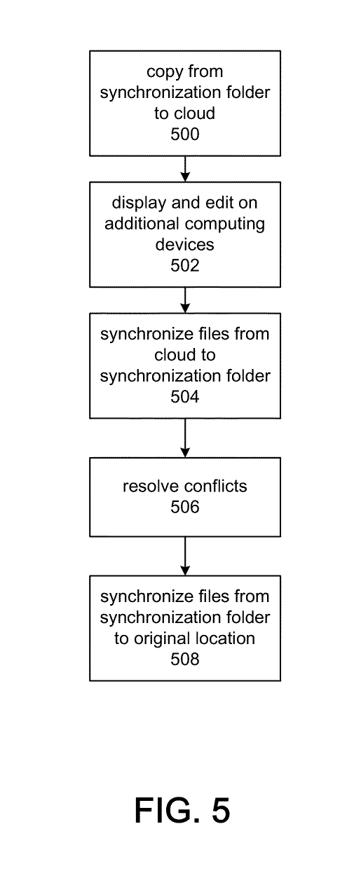

FIG. 5 depicts an embodiment of using synchronized sets of related files on multiple devices. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Operation 500 depicts copying files from a synchronization folder on a local computing device to one or more cloud services. Files that have been copied to the cloud may then be displayed or edited on additional computing devices, as depicted by operation 502.

Subsequent to editing on additional computing devices, the files in the cloud may be copied back to the synchronization folder on the original, local computing device, as depicted by operation 504. Editing of the documents on additional computing devices may create conflicts between the cloud version of the document and the version on the local device. Embodiments may perform conflict resolution, as depicted by operation 506, prior to updating documents in their original location. Conflict resolution may involve overriding or merging documents in the synchronization folder with documents in their original location. Once conflicts are resolved, documents may be copied to their original location as depicted by operation 508.

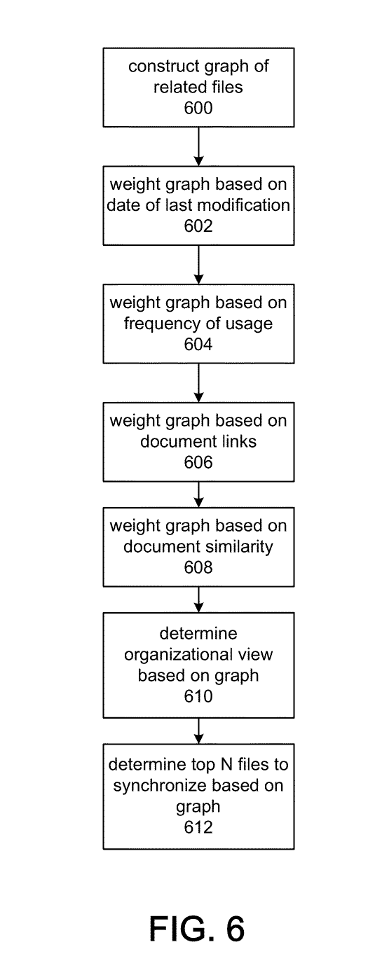

FIG. 6 depicts an embodiment of a mechanism for determining related files. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Operation 600 depicts constructing a graph of related files. A graph may be defined as any data structure indicative of links between related or potentially related files. Other elements, such as hyperlinks, may also be included.

Operation 602 depicts weighting the graph based on date of last modification. Weighting the graph may be considered to be modifying a data structure to indicate an increased or decreased probability or degree of relationship between two files. As depicted by operation 602, the graph may be weighted according to the date of last modification. Files modified within the same timeframe may have an increased degree of relationship, while files modified at different times may have a lower degree.

Operation 604 depicts weighting the graph based on frequency of usage. Files that are frequently used may be related. This might also be true of files that are used frequently together within the same time frame.

Operation 606 depicts weighting the graph based on links or references within the documents. This may include hyperlinks, references to filenames, and so forth. Referenced documents are more likely to be related than non-referenced documents. A higher degree of relationships may be found if the reference is mutual between two documents.

Document similarity may also be considered in selecting related files. Operation 608 depicts adjusting weights in the graph based on document similarity. This factor may be based on word count statistics, semantic analysis, keyword similarity, and so on.

A graph of related files may be used for a variety of purposes, including determining which files are to be synchronized. A graph may also be used in conjunction with a user interface to improve access to the set of related files. For example, as depicted by operation 610, a graph of related files may be employed to determine an organizational view within the user interface. For example, the graph might be used to group files into sets based on a degree of relationship between the files. Embodiments may also utilize a graph of related files when determining which files to synchronize. Operation 612 depicts using the graph to determine a set of files to determine, up to a maximum allowed based on a user's service level.

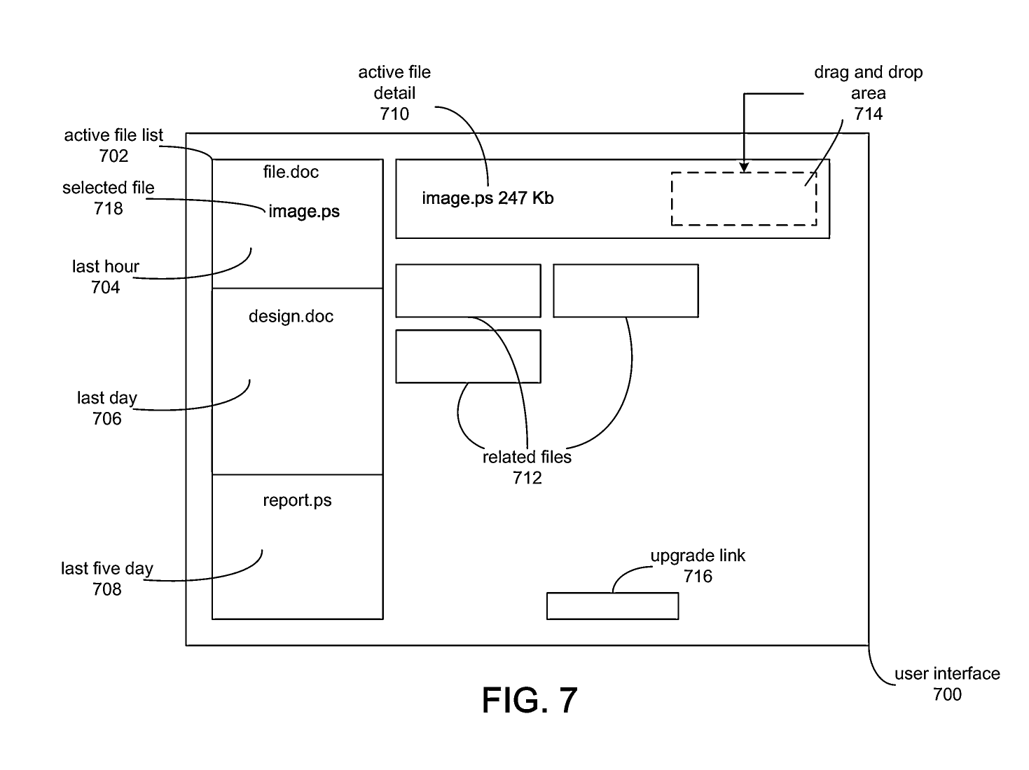

FIG. 7 depicts a user interface allowing for control of synchronization of related files sets. User interface 700 may comprise a number of elements such as active file list 702, active file detail 710, drag and drop area 714, and an area for displaying related files 712. Those of ordinary skill in the art will appreciate that the depicted elements are intended to be illustrative, and that many combinations and variants of the depicted elements may be provided while remaining consistent with aspects of the embodiments described herein.

User interface 700 may be provided as an interface for displaying which files are to be synchronized, including active files and related files. Access to files may be made available by launching a corresponding application in response to user input, such as a double-click on one of related files 712.

Currently active and recently active files may be displayed in active file list 702. The list may be segmented into groups, such as files active within the last hour 702, last day 706, and last five days 708. The user interface may provide means for selecting alternate orderings, groupings, filters, and so on.

Files in active file list 702 may be selected via a user input action such as a single click. When a file 718 in active file list 702 is selected, zero or more related files 712 may be displayed within user interface 700. Details about the active file may also be displayed, as depicted by user interface element 710. Details may include a wide variety of information concerning the file, such as size, type, usage statistics, author, synchronization status, and so on.

A drag and drop area 714 may be provided to allow for additional related files, hyperlinks, and other elements to be associated with the selected file from active file list 702. Files that are dragged into this area may be synchronized to one or more cloud services.

An upgrade link 716 may be provided to allow the user to upgrade his level of service. As described herein, a maximum number of active files and/or maximum number of related files may be defined by the level of service selected by the user. Upgrade link 716 may indicate the current service level, and suggest that upgrading may provide for improved service. The link might be highlighted when a user's actions are limited by his level of service. The user interface may be configured to activate a browser when upgrade link 716 is clicked on, the browser navigating to a website that allows for the user to select and pay for an improved level of service.

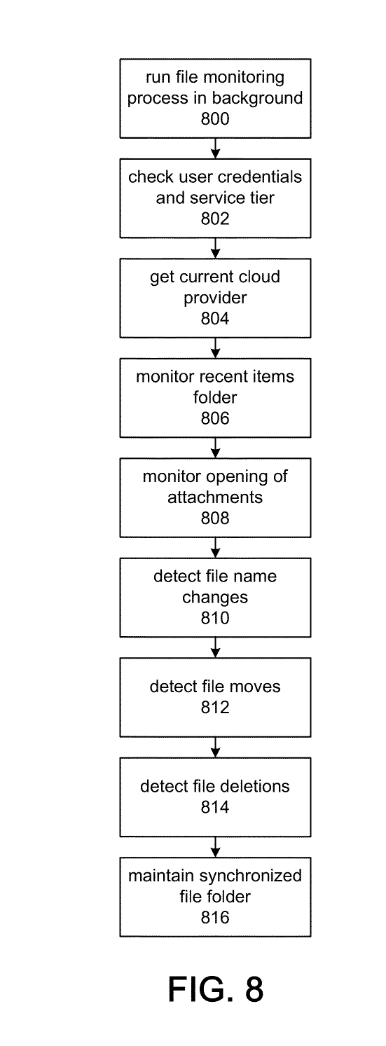

A process or software module may be configured to maintain a synchronization folder on a local computing device from which files will be synchronized to a cloud-based storage system. FIG. 8 depicts an embodiment of a background process for detecting and maintaining a synchronization folder. The background process may also initiate synchronization between the local folder and the cloud-based storage. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Operation 800 depicts running a file monitoring process in the background as a background process. For example, the process might be installed as a daemon process, service process and the like. Embodiments may configure the background process to run automatically upon startup of the computing device and/or operating system, or upon system resume.

Upon startup, as well as periodically, the user's credentials may be checked, as depicted by operation 802. The user's current service tier may also be determined. Operation 804 depicts determining the user's current cloud provider. Embodiments may also support multiple cloud providers, possibly mapping different file locations or types of locations to different providers. Determining the current cloud provider is depicted as operation 804.

The background process may monitor various events and locations to detect active files, or to detect recently active files. Operation 806 depicts monitoring a recent items folder or similar information source available on various operating systems. As depicted in operation 808, attachments opened in other programs, such as attachments opened from an email program, may also be monitored.

Operation 810 depicts continued monitoring of the file system of the computing device to detect file name changes. Embodiments may continue to synchronize files subsequent to a name change. Similarly, as depicted by operation 812, movement of files from one location to another may be tracked, and embodiments may continue to synchronize the file after it has been moved. Operation 814 depicts detecting when a synchronized file has been deleted. Embodiments may stop synchronizing the file after it has been deleted. Embodiments may provide mechanisms for removing deleted files from the cloud.

Operation 816 depicts maintaining a synchronization folder based in part on the various other operations depicted in FIG. 8. Maintaining the files may comprise copying modified files to a synchronization folder, removing deleted files, detecting and resolving conflicts between versions of files in the synchronization folder and versions in their original locations, and so on.

In an embodiment, recently used files and other data from third-party applications may be detected and synchronized automatically. Various mechanisms may be employed to interact with a third-party application and determine the identity and content of recently accessed files or data. The files or data may be extracted from the third-party application and synchronized with the cloud. This may be done, in various embodiments, by copying the extracted files or data to a synchronization folder referred to in FIG. 2. In addition, the content of the extracted files or data may be examined and used as a basis for identifying additional related files to synchronize. Examples of third-party applications include, but are not limited to, note taking applications, customer relations management applications, content management systems, document management systems, and so on.

The various processes, methods, and algorithms described herein may be embodied in various combinations of general-purpose and application-specific circuitry. The processes, methods, and algorithms described herein may be embodied in whole or in part by code modules executed by one or more processors of a computing system. The code modules may be stored on any type of non-transitory computer-readable storage medium, such as magnetic disk drives, optical disk drives, solid-state memory, random-access memory, read-only memory and so forth. Some or all of the code modules may be transferred between various memories and storage devices for various purposes, such as memory management by a computer operating system. In various embodiments, processes, code modules, and other elements may be distributed among multiple computing systems communicating via a computer network or other communications method. The results of the various processes, methods, and algorithms described herein may be stored in any type of non-transitory computer storage including volatile and non-volatile memory.

Aspects of the embodiments described herein may be used independently of one another, or combined in a variety of ways. All possible combinations and sub-combinations are intended to fall within the scope of the present disclosure. Various blocks or elements depicted in the figures may be added, removed, rearranged, or reconnected in various ways to form alternative embodiments. The embodiments described herein have been provided as examples, and are not intended to limit the scope of the present disclosure. Nothing in the description provided is intended to imply that any particular feature, characteristic, operation, step, block, or other element is required.

Conditional language such as “can,” “could,” “may,” “might,” “for example,” and so on is generally intended to convey that some embodiments include the recited element while other embodiments do not. Accordingly, unless specifically stated otherwise or required by context, such language is not intended to imply that the recited element is a mandatory component of any particular embodiment. The terms “comprising,” “having,” “including” and so forth do not exclude additional elements. When the term “or” is used to connect a list of elements, it is used inclusively to refer to one or more of the elements of the list.

What is claimed:

1. A system comprising:
a computing device comprising a memory and a processor, the computing device communicatively coupled to a storage device having a plurality of files stored thereon, the memory having stored thereon computer-readable instructions that, upon execution by the computing device, cause the system to:
determine that a first file of the plurality of files is marked for synchronizing with a copy of the first file maintained at a remote storage location and that the first file is in active use by a user of the computing device;
select a second file of the plurality of files for synchronizing with a copy of the second file to be formed at the remote storage location, the selecting based at least in part on a degree of relevance between the first file and the second file;
transmit information indicative of the second file to the remote storage location;
receive information indicative of a modification of the copy of the second file at the remote storage location; and
synchronize content of the second file stored on the storage device with content of the copy of the second file at the remote storage location, based at least in part on the information indicative of the modification.

2. The system of claim 1, further comprising computer-readable instructions that, upon execution by the computing device, cause the system to:
store an additional copy of the second file in a directory on the storage device.

3. The system of claim 1, further comprising computer-readable instructions that, upon execution by the computing device, cause the system to:
determine a provider of a remote storage location, the determination based at least in part on a mapping between a property of the first file and the provider.

4. The system of claim 1, further comprising computer-readable instructions that, upon execution by the computing device, cause the system to:
receive information indicative of a file that was active at the remote storage location.

5. The system of claim 1, further comprising computer-readable instructions that, upon execution by the computing device, cause the system to:
receive information indicative of a third file used by the user of the computing device, the third file maintained at the remote storage location;
receive information indicative of an additional file selected based on a degree of relevance between the third file and the additional file; and
display information indicative of the third file and the additional file to a user of the computing device.

6. A non-transitory computer-readable storage medium having stored thereon instructions that, upon execution by a computing device, cause the computing device to at least:
determine that a first file maintained by the computing device on a local storage device is associated with information indicative of synchronizing the first file with a copy of the first file at a remote storage location;
select a second file for synchronizing, based at least in part on determining a relationship between the first file and the second file;
transmit information indicative of the second file to the remote storage location;
receive information indicative of a modification of a copy of the second file maintained at the remote storage location; and
synchronize the second file stored on the storage device with the copy of the second file at the remote storage location, based at least in part on the information indicative of the modification.

7. The non-transitory computer-readable storage medium of claim 6, comprising further instructions that, upon execution by the computing device, cause the computing device to at least:
determine the relationship between the first and the second file based at least in part on at least one of time of use, frequency of use, information indicative of user input, document links, and similarity.

8. The non-transitory computer-readable storage medium of claim 6, comprising further instructions that, upon execution by the computing device, cause the computing device to at least:
determine that the first file was opened as an attachment to an email message; and
determine the relationship between the first and the second file based on the second file also being attached to the email message.

9. The non-transitory computer-readable storage medium of claim 6, comprising further instructions that, upon execution by the computing device, cause the computing device to at least:
store an additional copy of the second file in a directory on the storage device.

10. The non-transitory computer-readable storage medium of claim 6, comprising further instructions that, upon execution by the computing device, cause the computing device to at least:
receive information indicative of a user preference corresponding to a location for storing files; and
cause an additional copy of the second file to be stored on the remote storage location, based at least in part on the information indicative of the user preference.

11. The non-transitory computer-readable storage medium of claim 6, comprising further instructions that, upon execution by the computing device, cause the computing device to at least:
select the remote storage location from a plurality of remote storage locations based at least in part on a mapping between information associated with the second file and the remote storage location.

12. The non-transitory computer-readable storage medium of claim 6, comprising further instructions that, upon execution by the computing device, cause the computing device to at least:
maintain information indicative of a third file previously used by a user of the computing device; and
in response to receiving information indicating that the third file has no corresponding copy stored at the remote storage location, transmit information indicative of the third file to the remote storage location.

13. The non-transitory computer-readable storage medium of claim 6, comprising further instructions that, upon execution by the computing device, cause the computing device to at least:
select data from retrieval from a third-party application, the selection based at least in part on a relationship between the data and the first file.

14. A computer-implemented method comprising:
determining that a first file maintained by a computing device on a local storage device is associated with information indicative of synchronizing the first file with a copy of the first file at a remote storage location;
selecting a second file for synchronizing, based at least in part on determining a relationship between the first file and the second file;
transmitting information indicative of the second file to the remote storage location;
receiving information indicative of a modification of a copy of the second file maintained at the remote storage location; and
synchronizing the second file stored on the local storage device with the copy of the second file at the remote storage location, based at least in part on the information indicative of the modification.

15. The computer-implemented method of claim 14, further comprising:
determining the relationship between the first and the second file based on at least one of time of use, frequency of use, information indicative of user input, document links, and similarity.

16. The computer-implemented method of claim 14, further comprising:
determining that the first file was opened as an attachment to an email message; and
determining the relationship between the first and the second file based on the second file also being attached to the email message.

17. The computer-implemented method of claim 14, further comprising:
receiving information indicative of a user preference corresponding to a location for storing files; and
causing an additional copy of the second file to be stored on the remote storage location, based at least in part on the information indicative of the user preference.

18. The computer-implemented method of claim 14, further comprising:
selecting the remote storage location from a plurality of remote storage locations based at least in part on a mapping between information associated with the second file and the remote storage location.

19. The computer-implemented method of claim 14, further comprising:
maintaining information indicative of a third file previously used by a user of the computing device; and
in response to receiving information indicating that the third file has no corresponding copy stored at the remote storage location, transmitting information indicative of the third file to the remote storage location.

20. The computer-implemented method of claim 14, further comprising:
determining that a resource remote to the computing device has been accessed by the computing device; and
determining to store information indicative of the resource at the remote storage location, based at least in part on identifying a relationship between the resource and the first file.
